(19) United States
(12) Patent Application Publication
(10) Pub. No.: US 2017/0178648 A1
(43) Pub. Date: Jun. 22, 2017

(54) Enhanced Block Switching and Bit Allocation for Improved Transform Audio Coding

(71) Applicant: DOLBY INTERNATIONAL AB, Amsterdam Zuidoost (NL)

(72) Inventors: Michael SCHUG, Erlangen (DE); Harald MUNDT, Fürth (DE)

(73) Assignee: DOLBY INTERNATIONAL AB, Amsterdam Zuidoost (NL)

(21) Appl. No.: 15/378,255

(22) Filed: Dec. 14, 2016

Related U.S. Application Data
(60) Provisional application No. 62/269,345, filed on Dec. 18, 2015.

(30) Foreign Application Priority Data
Feb. 16, 2016 (EP) 16155551.1

(51) Int. Cl. G10L 19/02; G10L 19/032; G10L 19/26; G10L 19/002; G10L 19/025

(52) U.S. Cl. CPC G10L 19/0212; G10L 19/002; G10L 19/025; G10L 19/26; G10L 19/032

(57) ABSTRACT

The present document relates to methods and apparatus for audio coding. In particular, the present document relates to methods and apparatus for enhanced block switching and/or bit allocation in audio coding of transient-tonal signals. A method of encoding samples of an audio signal comprises determining a first measure indicative of transient characteristics of the audio signal, determining a second measure indicative of tonal characteristics of the audio signal, selecting a transform length for the audio signal on the basis of the first measure and the second measure, and applying a time-frequency transform to a block of samples of the audio signal in accordance with the selected transform length, to thereby obtain a block of frequency coefficients corresponding to the block of samples of the audio signal. Another method of encoding samples of an audio signal comprises applying a time-frequency transform to the audio signal in accordance with a selected transform length, to thereby obtain a sequence of blocks of frequency coefficients, wherein each block of frequency coefficients among said sequence corresponds to a respective block of samples of the audio signal, determining a measure of tonal characteristics for a frequency band of the audio signal based on the blocks of frequency components among said sequence, selecting, for the blocks of frequency coefficients among said sequence, a quantization step size for the frequency coefficients in said frequency band on the basis of said measure of tonal characteristics, and quantizing, for the blocks of frequency coefficients among said sequence, the frequency coefficients in said frequency band in accordance with the selected quantization step size.

### CROSS-REFERENCE TO RELATED APPLICATIONS

The present application claims priority to U.S. Provisional Patent Application No. 62/269,345, filed Dec. 18, 2015, and European Patent Application No. 16155551.1, filed Feb. 12, 2016, both of which are incorporated herein by reference in their entirety.

### TECHNICAL FIELD OF THE INVENTION

The present document relates to methods and apparatus for audio coding. In particular, the present document relates to methods and apparatus for enhanced block switching and/or bit allocation in audio coding of transient-tonal audio signals.

### BACKGROUND OF THE INVENTION

State of the art audio codecs (transform audio codecs) allow for a range of different transform lengths (transform sizes). These transform lengths may be defined in terms of samples, or in terms of time, taking into account sample rate. As an example, for the native video frame rate the transform length according to the AC-4 codec could have a value of 2048, 1024, 512, 256 or 128 (samples). The smallest transform length of 96 (samples) in AC-4 is possible e.g. for video frame rates of 29.97 or 30 frames per second. Also the mp3 (MPEG 1 Audio Layer III) and MC codecs provide for different transform lengths, i.e. long-blocks and short-blocks.

According to such audio codecs that provide for different transform lengths, transient audio signals (e.g. relating to the sound of castanets or cymbals) are encoded using a short transform length, i.e. the transient audio signals are transformed from the time domain to the frequency domain by a time-frequency transform (e.g. by a Modified Discrete Cosine Transform (MDCT)) using a short transform length (analysis window). This helps to reduce occurrence of audible artifacts, such as pre-echo, for the transient audio signals.

On the other hand, the above approach fails for transient-tonal audio signals, i.e. for audio signals that have both transient and tonal character, such as the Glockenspiel, for example. The reason is that typically, based on transient detection, short transform lengths are selected by the encoder, which implies a low frequency resolution of the time-frequency transform. However, for tonal signals the size of the frequency bands ideally should not be larger than a critical band with a bandwidth of approximately 100 Hz for the lowest frequencies when employing a perceptual model for quantization, such as the perceptual model of AC-4. Otherwise, the frequency resolution of an MDCT would be too low to observe energy variations that can occur e.g. for a low frequency tonal component of the audio signal. As a consequence, the masking threshold for quantization calculated by e.g. the psychoacoustic model of AC-4 would be too high, which may result in audible artifacts (e.g. low frequency rumble) after quantization of the MDCT coefficients. These audible artifacts may occur especially at low bitrates.

The present document addresses the above issues related to audio coding of transient-tonal content, for example the Glockenspiel, and describes methods and apparatus for improved audio coding of transient-tonal content. In particular, methods and apparatus for enhanced block switching and/or bit allocation in audio coding of transient-tonal signals are described.

### SUMMARY OF THE INVENTION

According to an aspect of the disclosure, a method of encoding samples of an audio signal is described. The method may comprise receiving the samples of the audio signal. The method may further comprise determining a first measure (transient measure) indicative of transient characteristics of the audio signal. The method may further comprise determining a second measure (tonality measure, e.g. short-term tonality measure) indicative of tonal characteristics of the audio signal. The first and second measures may be determined based on the audio signal, e.g. based on a predetermined number of samples of the audio signal, such as a frame or an integer fraction of a frame, for example. The second measure may be determined for a frequency band of the audio signal, e.g. a low frequency band or the lowest frequency band, again matching a similar timeslot of a frame or an integer fraction of a frame. The method may further comprise selecting a transform length (analysis window) for the audio signal on the basis of the first measure and the second measure. The method may yet further comprise applying a time-frequency transform to a block of samples of the audio signal in accordance with the selected transform length, to thereby obtain a block of frequency coefficients corresponding to the block of samples of the audio signal. The number of samples in the block of samples may be given by the selected transform length (e.g. when expressed in terms of samples).

Configured as above, the proposed method detects cases that would result in audible artifacts before deciding on the transform length. Accordingly, switches to the shortest transform lengths provided for by the applicable audio codec may be avoided for a transient-tonal signal. Thus, audible artifacts, such as low-frequency rumble, that would otherwise occur for transient-tonal signals are avoided by the proposed method. Since calculating the tonality measure may be necessary also in the context of encoding spectral band extension parameters (ASPX) and can thus be reused, the proposed method does not require a significant increase in complexity, if any. Lastly, the transform length may be chosen such that good energy concentration in time and frequency, and thus good coding gain, is achieved. In summary, the proposed method provides for low complexity transform length control such that audible artifacts for transient-tonal signals are avoided and the selected transform length yields good energy concentration in time and frequency, and thus good coding gain.

The time-frequency transform may be a MDCT, and the frequency coefficients may be MDCT coefficients. Other examples of time-domain to frequency-domain transformations (and the resulting block of frequency coefficients) are transforms such as the Modified Discrete Sine Transform (MDST), the Discrete Fourier Transform (DFT) and the Modified Complex Lapped Transform (MCLT). In general terms, the block of frequency coefficients may be determined from the corresponding block of samples using a time-domain to frequency-domain transform. Inversely, the block of samples may be determined from the block of frequency coefficients using the corresponding inverse transform. The MDCT is an overlapped transform which means that, in such cases, the block of frequency coefficients is determined from the block of samples and additional further samples of the audio signal from the direct neighborhood of the block of samples. In particular, the block of frequency coefficients may be determined from the block of samples and the directly preceding block of samples.

The second measure may be determined in the process of determining spectral band extension parameters for the audio signal. Determining the second measure may involve applying a filterbank to the audio signal to generate a filterbank representation of the audio signal. The filterbank may be a Quadrature Mirror Filter (QMF) filterbank, e.g. a complex valued (modulated, oversampled) QMF filterbank (sometimes referred to as pseudo-QMF filterbank). Determining the second measure may further involve determining the second measure on the basis of the filterbank representation of the audio signal. Said determining the second measure on the basis of the filterbank representation may involve, for each spectral band of a subgroup of spectral bands of the filterbank representation, and for each block of spectral band samples (typically about 20 ms), comparing a result of a linear prediction over time of a spectral coefficient for the respective spectral band to an actual value of said spectral coefficient. Said determining the second measure on the basis of the filterbank representation may further involve determining the second measure from the results of said comparisons for the spectral bands of the subgroup of spectral bands. Therein, larger deviations of the result of the linear prediction over time from the respective actual value may indicate smaller second measures (i.e. less tonality).

Re-using the tonality measure for determining spectral band extension parameters, or determining a tonality measure that may be reused for this purpose, or reusing the filterbank representation generated for either of these purposes, results in a very small, if any, increase of complexity compared to conventional methods. Making use of the filterbank representation, e.g. the QMF representation, the tonality measure can be calculated in a particularly simple and efficient manner.

Notwithstanding the advantage of complexity savings that can be achieved by using the tonality measure method described above, any other tonality measurements, e.g. based on an FFT or a long MDCT, could be used as well as the second measure.

The second measure may be delayed (e.g. fractionally delayed) with respect to the first measure so as to align the second measure with the first measure. Accordingly, appropriate selection of the transform length can be ensured for a given section of the audio signal.

Selecting the transform length may involve selecting the transform length from a predetermined set of transform lengths (e.g. the transform lengths provided by the applicable audio codec) in such a manner that the first measure satisfies (e.g. is below) a first threshold value (transient threshold) of the selected transform length for the first measure and the second measure satisfies (e.g. is below) a second threshold value (tonality threshold) of the selected transform length for the second measure. Therein, each transform length among the predetermined set of transform lengths may have (specific) associated first and second threshold values. Notably, the above threshold values and measures may be defined such that the threshold values are satisfied if they are not exceeded by respective measures, i.e. if the respective measure is below the respective threshold value. However, the present disclosure is not to be understood to be limited to such definition of threshold values and measures, and alternative definitions are understood to be comprised by the present disclosure.

Selecting the transform length may involve a candidate transform length selection step of selecting a candidate transform length from a predetermined set of transform lengths on the basis of the first measure. Selecting the transform length may further involve a transform length adjustment step of selecting, if the second measure does not satisfy (e.g. exceeds) a threshold value (tonality threshold) of the candidate transform length for the second measure, the next longer transform length from the predetermined set of transform lengths as a new candidate transform length. The transform length adjustment step may be repeated until the second measure satisfies (e.g. does not exceed) the threshold value of the new candidate transform length for the second measure anymore.

Different transform lengths among the predetermined set of transform lengths may have different associated threshold values for the second measure. Longer transform lengths may have less severe, i. e. less restrictive, thresholds for the second measure than shorter transform lengths. The thresholds associated with longer transform lengths may be less severe, i.e. less restrictive, in the sense that for a specific value of the second measure, the threshold for a longer transform length may be satisfied while the threshold for a shorter transform length may not be satisfied. In other words, a larger range of values of the second measure satisfy the second threshold associated with a longer transform length than the range of values of the second measure satisfying the second threshold associated with a shorter transform length. In a first example, the second measure is proportional to tonality, i.e. the second measure increases as tonality increases. In the first example, the second threshold is satisfied if the second measure does not exceed the second threshold. In this first example, the second threshold associated with longer transform lengths is greater than the second threshold associated with shorter transform lengths. In a second example, the second measure is inversely proportional to tonality, i.e. the second measure decreases as the tonality increases. In the second example, the second threshold is satisfied if the second measure exceeds the second threshold. In this second example, the second threshold associated with longer transform lengths is smaller than the second threshold associated with shorter transform lengths. Thus, the transform length may be tailored to the respective determined first and second measures, and an optimum compromise for the transform length in view of the transient character and tonal character of the audio signal can be found.

According to another aspect of the disclosure, a method of encoding samples of an audio signal is described. The method may comprise applying a time-frequency transform to the audio signal in accordance with a transform length (e.g. a pre-selected transform length), to thereby obtain a sequence of blocks of frequency coefficients, wherein each block of frequency coefficients among said sequence corresponds to a respective block of samples of the audio signal. The blocks of samples of the audio signal may form a sequence of adjacent blocks of samples of the audio signal. The method may further comprise determining a measure of tonal characteristics for a frequency band (e.g. scale factor band defined in the context of quantization using a psychoacoustic model) of the audio signal based on the blocks of frequency components among said sequence. Said measure may be determined on the basis of (the samples of) the audio signal, e.g. by analyzing (the samples of) the audio signal. The method may further comprise selecting, for the blocks of frequency coefficients among said sequence, a quantization step size (quantization step width) for the frequency coefficients in said frequency band on the basis of said measure of tonal characteristics. The method may yet further comprise quantizing, for the blocks of frequency coefficients among said sequence, the frequency coefficients in said frequency band in accordance with the selected quantization step size.

Configured as above, the proposed method is particularly applicable to cases in which the transform length has already been selected (possibly to accommodate for transients in the audio signal to be coded and possibly not taking into account tonality of the audio signal) or to edge cases in which the tonality measure had been just below the threshold, and in which the transform length cannot be changed anymore. The proposed method allows to avoid or alleviate audible artifacts, such as low frequency rumble, for tonal signals even for a selected short transform length. This is achieved by adjusting the quantization step size for the frequency coefficients in at least a frequency band of the audio signal in accordance with a determined tonality measure, to balance for possibly sub-optimal energy concentration in the frequency coefficients due to inappropriate choice of the transform length, and to thereby reduce quantization errors in the frequency band. By determining the tonality measure on the basis of the frequency coefficients, the method does not require application of additional time-frequency transforms to the audio signal for determining the tonality measure, such as a Fast Fourier Transform (FFT), for example, thus curbing an increase in computational complexity.

The time-frequency transform may be a MDCT, and the frequency coefficients may be MDCT coefficients. Other examples of time-domain to frequency-domain transformations (and the resulting block of frequency coefficients) are transforms such as MDST, DFT and MCLT. In general terms, the block of frequency coefficients may be determined from the corresponding block of samples using a time-domain to frequency-domain transform. Inversely, the block of samples may be determined from the block of frequency coefficients using the corresponding inverse transform.

Determining the measure of tonal characteristics may involve an averaging step of determining, for each frequency coefficient in said frequency band, an indication of an averaged (or accumulated) energy for the respective frequency coefficient, by averaging (or summing) over frequency coefficients of corresponding frequency in each of the blocks of frequency coefficients among said sequence. The averaging step may result in a time-averaged (or time-accumulated) spectrum of the audio signal. Said averaging step may involve summation of squares of frequency coefficients. Determining the measure of tonal characteristics may further involve a determination step of determining the measure of tonal characteristics on the basis of the averaged (or accumulated) energies for the frequency components in said frequency band.

By averaging or summing over time, instead of over frequency, the accuracy of the power assessment for a particular frequency bin is improved. This enables to reliably detect tonality in the audio signal, which would otherwise not be possible. Moreover, said averaging or summing over time can be performed in a computationally effective manner, so that the proposed method can be performed in a computationally cheap manner.

The determination step may involve detecting an increase or decrease (dip) from the averaged (or accumulated) energy of one frequency coefficient in said frequency band to the averaged (or accumulated) energy of an adjacent (i.e. adjacent in frequency) frequency coefficient in said frequency band. Detection of a strong increase or decrease may result in a measure of tonal characteristics that indicates presence of tonality in the audio signal, wherein the value of the measure may be positively correlated with the severity of the increase or decrease. Detecting increases or decreases from the one frequency coefficient to the adjacent frequency coefficient may involve comparing a difference between the averaged (or accumulated) energies of these frequency coefficients to a threshold for an increase or to a threshold for a decrease, depending on the sign of the difference. The thresholds for the increase and the decrease may be equal to each other. Further, the thresholds for the increase and the decrease may depend on (e.g. be chosen in accordance with) the transform length.

Alternatively or in addition determining the measure of tonal characteristics may involve applying a further frequency transform to the frequency coefficients in each block of frequency coefficients among said sequence. Determining the measure of tonal characteristics may involve performing linear prediction over time for the frequency coefficients in said frequency band.

Selecting the quantization step size may involve enforcing finer quantization for the frequency coefficients in said frequency band for higher values of the measure of tonal characteristics. Selection of the quantization step size may be performed such that a quantization error for the highest-energy frequency coefficient in said frequency band is below the value of the low energy coefficients (or lowest energy coefficients) in said frequency band. An even lower threshold for the quantization error for the highest-energy frequency coefficient in said frequency band may be selected if the bandwidth of a single energy coefficient is larger than a critical bandwidth.

Thereby, audible artifacts for a transient-tonal audio signal, especially at low frequencies, such as low frequency rumble, can be avoided or at least alleviated. Notably, this effect is achieved even for inappropriate choice of the transform length for the transient-tonal audio signal.

It should be noted that the methods described in the present document may be applied to audio encoders. Any statements made above with respect to such methods are understood to likewise apply to encoders for encoding samples of an audio signal.

Consequently, according to another aspect of the disclosure an encoder for encoding samples of an audio signal is described. The encoder may comprise a transient determination unit adapted to determine a first measure indicative of transient characteristics of the audio signal. The encoder may further comprise a tonality determination unit adapted to determine a second measure indicative of tonal characteristics of the audio signal. The encoder may further comprise a transform length selection unit adapted to select a transform length for the audio signal on the basis of the first measure and the second measure. The encoder may yet further comprise a time-frequency transform unit adapted to apply a time-frequency transform to a block of samples of the audio signal in accordance with the selected transform length, to thereby obtain a block of frequency coefficients corresponding to the block of samples of the audio signal.

According to another aspect of the disclosure, an encoder for encoding samples of an audio signal is described. The encoder may comprise a time-frequency transform unit adapted to apply a time-frequency transform to the audio signal in accordance with a transform length, to thereby obtain a sequence of blocks of frequency coefficients, wherein each block of frequency coefficients among said sequence corresponds to a respective block of samples of the audio signal. The encoder may further comprise a tonality determination unit adapted to determine a measure of tonal characteristics for a frequency band of the audio signal based on the blocks of frequency components among said sequence. The encoder may further comprise a quantization step selection unit adapted to select, for the blocks of frequency coefficients among said sequence, a quantization step size for the frequency coefficients in said frequency band on the basis of said measure of tonal characteristics. The encoder may yet further comprise a quantization unit adapted to quantize, for the blocks of frequency coefficients among said sequence, the frequency coefficients in said frequency band in accordance with the selected quantization step size.

According to another aspect, a software program is described. The software program may be adapted for execution on a processor and for performing the method steps outlined in the present document when carried out on a computing device.

According to another aspect, a storage medium is described. The storage medium may comprise a software program adapted for execution on a processor and for performing the method steps outlined in the present document when carried out on a computing device.

According to a further aspect, a computer program product is described. The computer program may comprise executable instructions for performing the method steps outlined in the present document when executed on a computer.

It should be noted that the methods and apparatus including its preferred embodiments as outlined in the present document may be used stand-alone or in combination with the other methods and systems disclosed in this document. Furthermore, all aspects of the methods and apparatus outlined in the present document may be arbitrarily combined. In particular, the features of the claims may be combined with one another in an arbitrary manner.

### DESCRIPTION OF THE DRAWINGS

The invention is explained below in an exemplary manner with reference to the accompanying drawings, wherein:

FIG. 1 is a block diagram illustrating an example of a scheme (method) for improved transform size selection;

FIG. 2 is a flow chart illustrating an example of the scheme for improved transform size selection;

FIG. 3 is a flow chart illustrating an example of a step in the flow chart of FIG. 2;

FIG. 4 is a flow chart illustrating an example of a scheme (method) for improved bit allocation;

FIG. 5 is a flow chart illustrating an example of a step in the flow chart of FIG. 4;

FIG. 6 schematically illustrates an example of details of a step in the flow chart of FIG. 5;

FIG. 7 is an exemplary graph illustrating an increase in frequency resolution that is obtainable by the scheme of FIG. 4;

FIG. 8 schematically illustrates an apparatus for executing the scheme of FIG. 2; and

FIG. 9 schematically illustrates an apparatus for executing the scheme of FIG. 4.

### DETAILED DESCRIPTION OF THE INVENTION

The present document describes two schemes (methods) for addressing the above issues. These schemes, directed to improved transform size selection and improved bit allocation, respectively, may be employed individually or in conjunction with each other.

### Improved Transform Size Selection

First, a scheme (method) for improved transform size selection (transform length selection) will be described.

As indicated above, transform audio codecs typically allow for different transform lengths depending on the audio content to be encoded. For bitrate-efficient transform coding it is essential that the signal energy is concentrated as much as possible in only few time-frequency bins. For example, transient signals such as castanets should be coded with short transform lengths such that a castanet attack is isolated (e.g. appearing in only two short overlapping transforms). This may be achieved by providing a broadband transient detector in the time domain which selects small transform lengths for transient signals.

On the other hand, tonal signals such as pitch pipes require long transform lengths, such that tones have significant energy only in few bins of a long transform length. In signal sections that exhibit tonal and transient characteristics at the same time (e.g. the Glockenspiel), a compromise for the transform length must be found. Such compromise may be found by optimizing (i.e. maximizing) an energy concentration measure, which however would result in significant computational complexity.

The proposed scheme for improved transform size selection provides for low complexity transform length control such that the selected transform length yields good energy concentration in time and frequency and thus good coding gain for transient-tonal signals. The proposed scheme is applicable to any audio codec that allows for different transform lengths, such as mp3, AAC, HE-AAC, AC-4, and the like.

Broadly speaking, the proposed scheme for improved transform size selection combines a transient measure with a (short-term) tonality measure for transform size control. Calculating the tonality measure may be necessary also for encoding spectral band extension parameters, so that there is virtually no increase in complexity when employing the proposed scheme. As an outcome of employing the proposed scheme, very short transform sizes are avoided for transient-tonal signal sections, thereby avoiding tone related artifacts, such as low frequency rumble.

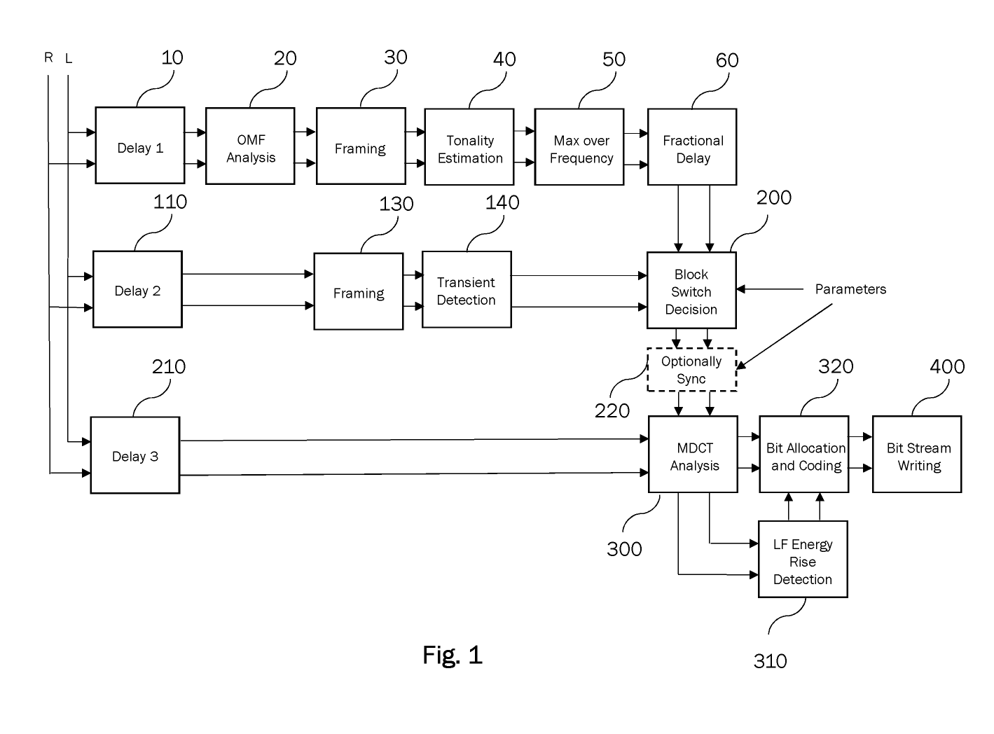

FIG. 1 is an exemplary block diagram illustrating an overview of encoding an audio signal when employing the proposed scheme (method) for improved transform size selection.

The method receives samples of an audio signal, e.g. Pulse Code Modulation (PCM) samples, as an input. The audio signal may have one or more channels, e.g. may be a stereo signal with a pair of channels. However, the present disclosure shall not be limited to any particular number of channels. After optional delay at delay block 10, the audio signal (i.e. the samples of the audio signal) may be subjected to a filterbank analysis, e.g. a QMF analysis, at filterbank analysis block 20 to obtain a filterbank representation of the audio signal. Without intended limitation, reference will be made to a QMF filterbank in the remainder of this document. After framing at framing block 30, tonality estimation on the basis of the QMF representation may be performed at tonality estimation block 40. Said tonality estimation may be performed for each frame, i.e. on a frame-by-frame basis, or for each integer fraction of a frame, e.g. for each half-frame. Further, an estimate of tonality may be obtained for each one among a predetermined set of QMF bands. In particular, an estimate of tonality may be obtained for each one among a given number of the lowest QMF bands (i.e. QMF bands corresponding to the lowest frequencies), e.g. for each of the six lowest QMF bands. At maximum over frequency block 50, a maximum over frequency of the estimates of tonality obtained by the tonality estimation block 40 may be obtained. For example, a maximum of the estimates of tonality for the given number of lowest QMF bands may be obtained. The maximum obtained at the maximum over frequency block 50 may serve as a tonality measure of the audio signal (measure of tonal characteristics of the audio signal; second measure in the claims). Alternatively, an average (or other suitable statistic measure) of the estimates of tonality for the given number of lowest QMF bands may be obtained, and said average (or other suitable statistic measure) may serve as the tonality measure of the audio signal.

The samples of the audio signal may also be provided to transient detection block 140, after optional delay at delay block 110. After framing at framing block 130, the transient detection block 140 may determine a transient measure of the audio signal (measure of transient characteristics of the audio signal; first measure in the claims). The transient measure may be determined on the basis of the samples (e.g. PCM samples) of the audio signal. The transient measure may be determined for each frame, i.e. on a frame-by-frame basis, or for each integer fraction of a frame, e.g. for each half-frame. Determining the transient measure may involve detecting steep increases or decreases of energy from one sample of the audio signal to the next (or from a small group of contiguous samples to the next), wherein such steep increases or decreases are indicative of transients in the audio signal.

The tonality measure is optionally delayed, e.g. fractional delayed, at fractional delay block 60. The fractional delay and the first to third delays at delay blocks 10, 110, 210, respectively, may be chosen such that the tonality measure has the same look-ahead as the transient measure, wherein the look-ahead is required for block switch decision at block switch decision block 200. The first to third delays at delay blocks 10, 110, 210 may be determined by the specifics of the encoder or audio codec. Selection of the fractional delay may take into account, in addition to the respective delays at delay blocks 10, 110, 210, also the delay inherent to the QMF filterbank analysis. After optional fractional delay at the fractional delay block 60, the transient measure may be provided to the block switch decision block 200, at which a transform length is selected, e.g. from a predetermined set of transform lengths, in accordance with the relevant audio codec. Said selection of transform length may be performed on the basis of the transient measure and the tonality measure.

The samples of the audio signal may also be provided to a time-frequency transform block, e.g. MDCT analysis bock 300, after optional delay at delay block 210. Without intended limitation, reference will be made to a MDCT as an example of a time-frequency transform in the remainder of this document. The transform length selected by the block switch decision block 200 may be provided to the MDCT analysis block 300, after optional synchronization at synchronization block 220. The MDCT may be performed in accordance with the selected transform length and yields a sequence of blocks of frequency coefficients (MDCT coefficients). Each block of frequency coefficients corresponds to a block of samples of the audio signal. The number of samples in each block of samples of the audio signal is given by the transform length.

At bit allocation and coding block 320, each block of the sequence of blocks of frequency coefficients is quantized in accordance with a quantization step size that is chosen for each frequency coefficient (i.e. for each MDCT line), or that is chosen jointly for bands (scale factor bands) of frequency coefficients. The choice of quantization step size for a given frequency coefficient corresponds to an allocation of a number of bits to the given frequency coefficient for quantization. The actual number of allocated bits may differ, e.g., in cases where frequency coefficients are noiselessly coded, the actual number of allocated bits may be the number of bits required for noiselessly coding (e.g. by Huffman coding) the quantized values. The choice of the quantization step size, e.g. for frequency coefficients corresponding to low frequencies, may be adjusted in accordance with an output of low frequency (LF) energy rise detection block 310. The LF energy rise detection block 310 may detect strong increases or decreases in energy from one frequency coefficient to an adjacent (i.e. adjacent in frequency) frequency coefficient. Such strong increases or decreases may be increases or decreases with an absolute magnitude above a given threshold. Upon detection of such increase or decrease (in general, change), the quantization step size for respective frequency coefficients or a respective frequency band comprising the respective frequency coefficients may be decreased (i.e. the number of allocated bits for quantization may be increased). At bit stream writing block 400, the quantized frequency coefficients may be written to a bit stream.

Notably, the above-described operations at each block may be performed for each of the channels of the audio signal. The selection of the transform length at the block switch selection block 200 may be performed jointly for all channels, taking into account the tonality measures and transient measures for each of the channels. For example, the selection of the common transform length for the channels of the audio signal at the block switch selection block 200 may be performed such that both the transient threshold and the tonality threshold are satisfied (e.g. not exceeded) for any of the jointly coded channels.

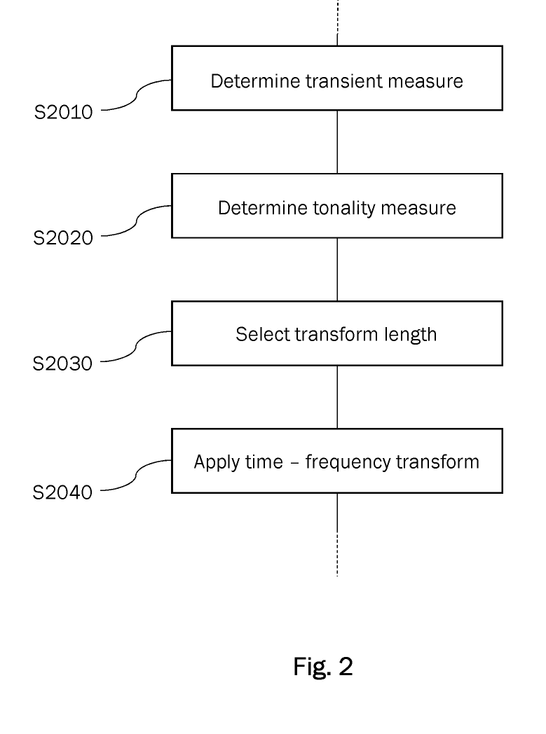

The proposed scheme for improved transform size selection is now described in more detail with reference to the flow chart illustrated in FIG. 2.

At step S2010, a transient measure of the audio signal (first measure indicative of transient characteristics of the audio signal in the claims) is determined. The transient measure may be determined on the basis of the samples (e.g. PCM samples) of the audio signal. The transient measure may be a short-term transient measure. The transient measure may be determined on a frame basis, or on the basis of an integer fraction of a frame, e.g. half-frame, quarter-frame, etc. The transient measure may indicate a severity of transients in an analyzed portion of the audio signal, wherein higher transient measures may be indicative of more severe transients. The presence of transients, as well as the severity thereof may be detected by determining differences in energy between successive samples, or between successive groups of samples (e.g. 128 samples, or 1/16 of a frame), of the audio signal. If groups of samples are considered, differences between averaged energies (averaged over the samples of respective groups of samples) may be determined. Strong increases in energy from one sample (or one group of samples) to the next may be indicative of a transient, wherein the magnitude of the increase may be indicative of the severity of the transient. For example, presence of a transient may be determined if the absolute magnitude of an increase or decrease is above a given threshold.

At step S2020, a tonality measure (second measure indicative of tonal characteristics of the audio signal in the claims) is determined (estimated). The tonality measure may be determined on the basis of the samples of the audio signal. The tonality measure may be determined on a frame basis, or on the basis of an integer fraction of a frame, e.g. half-frame, quarter-frame, etc. That is, the tonality measure may be determined on the basis of a number of samples corresponding to a frame or an integer fraction of a frame. Determining the tonality measure may involve deriving (generating) a filterbank representation (e.g. complex-valued QMF filterbank representation) of the audio signal, e.g. by applying a filterbank to the audio signal. The filterbank representation may be generated for each of a plurality of analyzed portions of the audio signal. In one embodiment, 32 filterbank spectra are determined per frame. The tonality measure may be determined on the basis of the generated filterbank representation. Moreover, the tonality measure may be determined for a frequency band of the audio signal, e.g. a low frequency band or the lowest frequency band.

For example, tonality may be determined for each one among a given number of sub-bands of the filterbank representation, e.g. for a given (contiguous) number of the lowest frequency sub-bands of the filterbank representation. The entirety of these sub-bands may correspond to the above frequency band of the audio signal. In one embodiment, the filterbank representation has 64 sub-bands, and tonality is determined for each of the 6 lowest frequency sub-bands (e.g. covering 0-2250 Hz) of the filterbank representation. In each of these frequency sub-bands, tonality may be determined by performing linear prediction in time for the given frequency sub-band, and comparing the result of the linear prediction to the actual development over time in the given frequency sub-band (e.g. between consecutive filterbank spectra). Good agreement between linear prediction and actual development over time indicates high tonality, whereas poor agreement indicates low tonality. The measure of tonality may be obtained as the maximum of the tonalities over the given number of frequency sub-bands (e.g. over the 6 lowest frequency bands).

Notably, generating a filterbank representation of the audio signal and determining the tonality measure may be performed in the process of determining spectral band extension parameters for the audio signal. In other words, the filterbank representation generated in the process of determining the spectral band extension parameters may be reused for the purpose of determining the tonality measure. In certain cases, determining the spectral band extension parameters may require determining the tonality measure, so that the tonality measure may be reused for the purpose of transform length selection, without additional computational complexity in encoding. Of course, also the converse case is feasible, i.e. that the filterbank representation or tonality measure determined for transform length selection is reused for determining the spectral band extension parameters.

It is understood that the above steps S2010 and S2020 may be performed in any order.

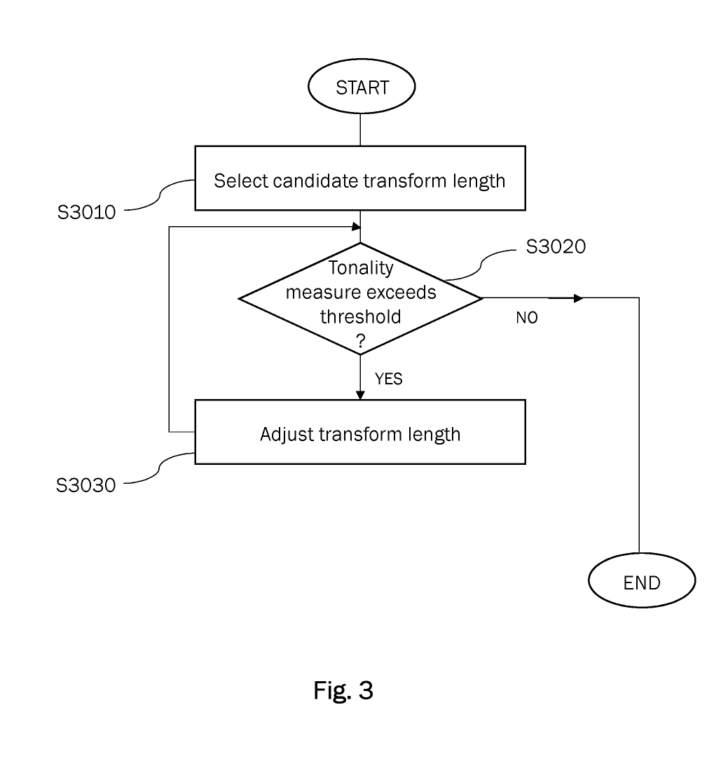

At step S2030, a transform length is selected. The transform length may be selected e.g. from a predetermined set of transform lengths provided by the audio codec in question. The transform length may be determined on the basis of the transient measure and the tonality measure. To this end, the tonality measure may be delayed (e.g. fractionally delayed) with respect to the transient measure such that the tonality measure and the transient measure are time-aligned. This allows to appropriately decide on the best transform size for the current encoder frame or integer fraction thereof. Selecting the transform length may involve applying a heuristic algorithm that receives the transient measure and the tonality measure as inputs and outputs an appropriate transform length, on the basis of the input transient measure and tonality measure. The transform length may be selected, e.g. from the predetermined set of transform lengths, such that the transient measure satisfies (e.g. is below) a transient threshold (first threshold value in the claims) of the selected transform length, and the tonality measure satisfies (e.g. is below) a tonality threshold (second threshold value in the claims) of the selected transform length. An example for such selection will be described below with reference to FIG. 3.

Notably, when deriving a common transform length for two or more audio channels, e.g. for an audio channel pair, the transient and tonality measures of all channels may be simultaneously taken into account. In this case, the transform length may be selected such that the tonality measures of all channels satisfy (e.g. are below) the tonality threshold of the selected transform length, and the transient measures of all channels satisfy (e.g. are below) the transient threshold of the selected transform length. For example, selection of the common transform length may be performed based on a largest one of the respective tonality measures of the channels.

At step S2040, a time-frequency transform (e.g. MDCT) is applied to the samples of the audio signal in accordance with the selected transform length (i.e. using the selected transform length as analysis window). That is, the time-frequency transform is applied to a block of samples of the audio signal, wherein the number of samples in the block are given by the transform length (e.g. are equal to the transform length or depend on the transform length), to obtain a block of frequency coefficients (e.g. MDCT coefficients) that corresponds to the block of samples. For the particular case of the MDCT, the transform length is twice the number of MDCT coefficients in the block, due to the overlap between subsequent analysis windows in the MDCT.

FIG. 3 exemplarily illustrates details of step S2030 in FIG. 2. Broadly speaking, selecting the transform length may proceed in two steps: First, based on the transient measure, a transform length is selected. Second, if an associated tonality threshold is not satisfied (e.g. exceeded), the next longer transform length is selected. The two steps may be repeated until a transform length is found for which the tonality threshold is satisfied (e.g. not exceeded anymore).

In more detail, at step S3010 a candidate transform length is selected, e.g. from the predetermined set of transform lengths. The selection may be performed on the basis of the transient measure. For example, the largest available transform length (e.g. among the predetermined set of transform lengths) for which the transient measure satisfies (e.g. does not exceed) the transient threshold of that transform length may be selected as the candidate transform length. Step S3010 may be referred to as a candidate transform length selection step.

At step S3020, it is determined whether the tonality measure of the (analyzed portion of the) audio signal satisfies (e.g. does not exceed) the tonality threshold of the candidate transform length. If the tonality measure does not satisfy (e.g. exceeds) the tonality threshold of the candidate transform length (NO as step S3020), the method proceeds to step S3030. If the tonality measure satisfies (e.g. does not exceed) the tonality threshold of the candidate transform length (YES as step S3020), the candidate transform length is selected as the transform length and the processing of step S2030 ends.

At step S3030, the next longer available transform length is selected as (new) candidate transform length, e.g. from the predetermined set of transform lengths. Step S3030 may be referred to as a transform length adjustment step. After step S3030, the method returns to the determination of step S3020. Accordingly, the transform length adjustment step is repeated until the tonality measure is determined to satisfy (e.g. not exceed) the tonality threshold of the candidate transform length.

In the above, different tonality thresholds and/or transient thresholds may be defined for (i.e. assigned to) different transform lengths. For example, each available transform length may have an associated tonality threshold and/or an associated transient threshold. In embodiments, the tonality thresholds may become less severe (e.g. increase) with the size (length) of their associated transform lengths. In other words, different transform lengths (e.g. among the predetermined set of transform lengths) may have different associated threshold values for the second measure in accordance with their respective sizes, e.g. such that longer transform lengths have less severe (e.g. higher) thresholds for the tonality measure than shorter transform lengths. As noted previously, the thresholds associated with longer transform lengths may be less severe, i.e. less restrictive, in the sense that for a specific value of the second measure, e.g., for a specific tonality measure, the threshold for a longer transform length may be satisfied while the threshold for a shorter transform length may not be satisfied.

In general, selecting the transform length at step S2030 in FIG. 2 is performed such that the transform length that is eventually selected has an associated tonality threshold that is satisfied (e.g. not exceeded) by the tonality measure of the (analyzed portion of the) audio signal, as indicated above. Moreover, the transform length that is eventually selected has an associated transient threshold that is satisfied (e.g. not exceeded) by the transient measure of the (analyzed portion of the) audio signal

In summary, the proposed method for improved transform size selection combines a transient and a (short term) tonality measure to improve selection of the transform length for audio coding depending on the audio content of the audio signal. By taking into account both the transient measure and the tonality measure, an optimum compromise can be found for the transform length and good energy concentration can be achieved. Moreover, by using a tonality measure that is available already in a spectral band extension audio encoder, or that may be re-used by such encoder, no significant additional complexity is required for implementing the proposed method for improved transform size selection.

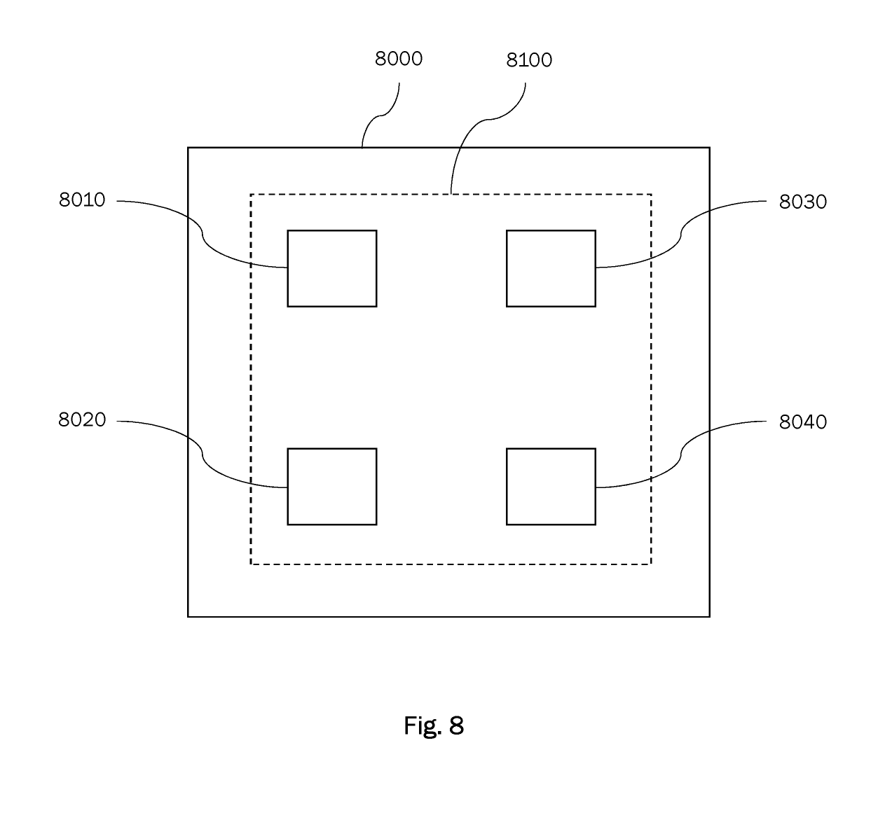

It is understood that the proposed method for improved transform size selection may be implemented by an encoder for encoding samples of an audio signal. Such encoder may comprise respective units adapted to carry out respective steps described above. An example of such encoder 8000 is schematically illustrated in FIG. 8. For instance, such encoder 8000 may comprise a transient determination unit 8010 adapted to perform aforementioned step S2010, a tonality determination unit 8020 adapted to perform aforementioned step S2020, a transform length selection unit 8030 adapted to perform aforementioned step S2030, and a time-frequency transform unit 8040 adapted to perform aforementioned step S2040. It is further understood that the respective units of such encoder may be embodied by a processor 8100 of a computing device that is adapted to perform the processing carried out by each of said respective units, i.e. that is adapted to carry out each of the aforementioned steps.

### Improved Bit Allocation

Next, a scheme (method) for improved bit allocation will be described. This scheme may be employed subsequently to the scheme for improved transform size selection, as well as in cases in which the scheme for improved transform size selection has not been employed. In particular, the scheme for improved bit allocation may be employed in cases in which a value for the transform length that would cause audible artifacts for a tonal component of an audio signal has already been selected. The scheme for improved bit allocation may relate to a modification to blocks 310 and 320 illustrated in FIG. 1.

In the example of the AC-4 codec, an MDCT is applied to the audio signal. A psychoacoustic model is calculated for the so called scale factor bands (groups of frequency sub-bands, i.e. groups of MDCT lines). All MDCT coefficients of a scale factor band are quantized with the same scale factor, wherein the scale factor determines the quantizer step size (quantization step size). In case of the two lowest transform lengths of 128 and 256 samples for the native frame rate of AC-4 or 96 and 192 samples for a frame rate of 30 frames per second, a scale factor band for the lowest scale factor consists of 4 MDCT lines. This translates into a bandwidth of the lowest scale factor band of 4/128*48000 Hz/2=750 Hz for the transform length of 128 samples for the native frame length of 2048 samples at a sample rate of 48 kHz, or into a bandwidth of 4/256*48000 Hz/2=375 Hz for a transform length of 256 samples. The worst case frequency resolution is obtained for a video frame rate of 30 fps when the smallest transform length of 96 samples is chosen at an internal sample rate of 46080 Hz, namely 4/96*46080/2=960 Hz. This corresponds to approximately the first 8 critical bands (measured in bark) of the auditory system encoded commonly in one scale factor band.

Switching to and encoding with short transform lengths usually works in audio codecs such as AC-4, because the short transform lengths (short blocks) are used for transient parts of a signal. Said transient parts usually can be expected to have a relatively flat energy spectrum so that encoding multiple critical bands with one common quantizer step size is acceptable.

However, if the signal consists of e.g. a transient with an additional low frequency tonal component, there will be strong energy differences within especially the lowest scale factor bands. With the frequency resolution attainable for short transform lengths, those energy differences are not visible by the perceptual model and the introduced quantization noise will be so large that it becomes audible in the lower energy parts of the scale factor band in question. Especially a too coarse quantization of the frequency region below the center frequency of a tonal signal component will be more audible, because of steeper masking slope compared to that towards high frequencies.

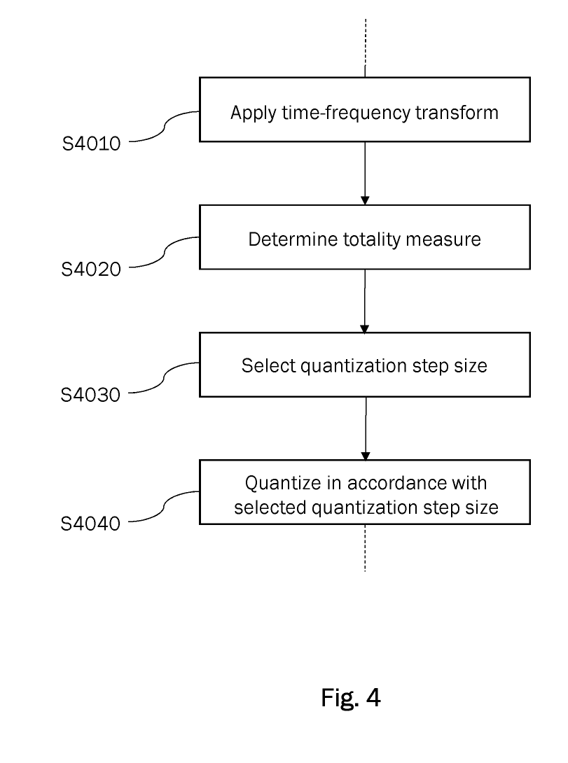

This issue is addressed by the proposed scheme for improved bit allocation which is now described in more detail with reference to the flow chart illustrated in FIG. 4.

At step S4010, a time-frequency transform (e.g. a MDCT) is applied to the samples of the audio signal in accordance with a (pre-)selected transform length (i.e. using an analysis window determined by the transform length; for the case of MDCT, the analysis window is determined by the transform length of the previous, the current and the next MDCT). As an output, step S4010 yields a sequence of blocks of frequency coefficients (e.g. MDCT coefficients). Each block of frequency coefficients in said sequence corresponds to a respective block of samples, wherein the number of samples in each block of samples is given by the transform length. The number of blocks of frequency coefficients in the sequence may depend on the transform length. For example, the sequence may comprise 2, 4, 8, or 16 blocks of frequency coefficients. Further, the blocks of samples corresponding to the sequence of blocks of frequency coefficients may correspond to a frame or a half-frame, depending on the relevant audio codec.

Notably, the (pre-)selected transform length may not correspond to an optimum compromise for the transform length, so that energy concentration might not be optimal and/or audible artifacts due to tonality of the audio signal might occur. Step S4010 corresponds to aforementioned step S2040 in FIG. 2, with the difference that the transform length used in step S4010 is pre-selected, possibly without regard to tonality of the audio signal.

At step S4020, a tonality measure (measure of tonal characteristics in the claims) is determined for a frequency band (e.g. a low frequency band, or a lowest frequency band) of the audio signal. Said determination may be based on the blocks of frequency coefficients among said sequence of blocks of frequency coefficients, e.g. said determination may involve analyzing the blocks of frequency coefficients among said sequence. Using the existing frequency coefficients (e.g. MDCT coefficients) allows to avoid significant additional computational complexity. The frequency band of the audio signal may correspond to a scale factor band (e.g. the lowest scale factor band) of a psychoacoustic model used for quantization of the frequency coefficients. The frequency band may also correspond to a given number of consecutive lowest scale factor bands.

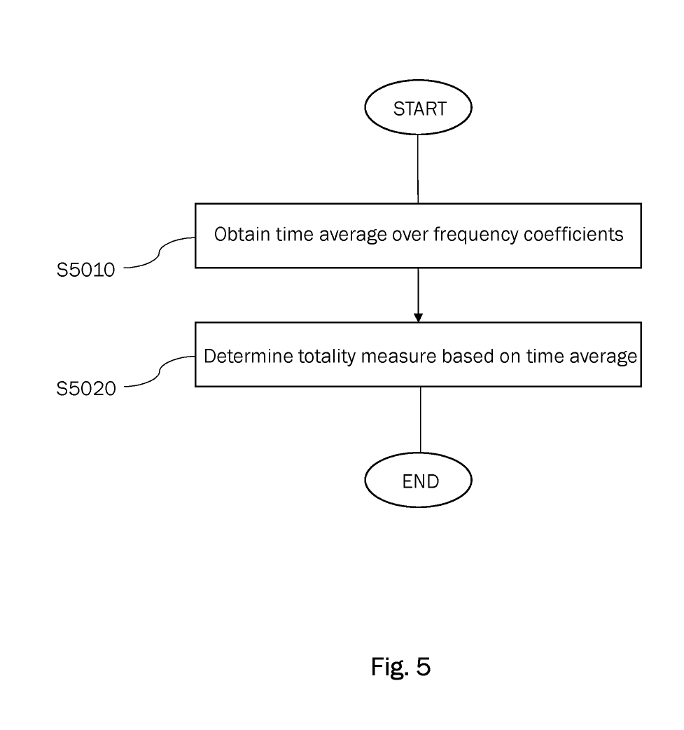

Further, said determination may involve analyzing consecutive blocks of frequency coefficients among said sequence, to thereby increase accuracy of the determination. An example for such determination will be described below with reference to FIG. 5. Step S4020 may also be said to detect the possibility of audible artifacts (e.g. low frequency artifacts) in said frequency band of the audio signal.

At step S4030, a quantization step size (quantization step width) is selected for the blocks of frequency coefficients among said sequence. Said selection of the quantization step size may be performed on the basis of the tonality measure determined at step S4020. Moreover, selecting the quantization step size may involve enforcing finer quantization (i.e. smaller quantization step size) for the frequency coefficients in said frequency band for higher values of the measure of tonal characteristics, e.g. upon detection of tonality in said frequency band. Such finer quantization may be enforced e.g. by lowering the masking threshold of the psychoacoustic model for said frequency band, e.g. compared to the initial value calculated by the psychoacoustic model. In embodiments, a quantization step size is enforced for said frequency band in such a manner that the resulting quantization distortion of strong energy components in said frequency band is below the low energy components in said frequency band. Thereby, audible artifacts, e.g. low frequency artifacts, such as low frequency rumble, may be avoided or at least alleviated, and potentially sub-optimal coding gain due to too short transform lengths may be balanced (however at the cost of some “over-coding” of the stronger frequency coefficients in the frequency band). Enforcing a finer quantization may also be said to correspond to enforcing a higher Signal-to-Noise Ratio (SNR).

At step S4040, the frequency coefficients in said frequency band are quantized for the blocks of frequency coefficients among said sequence, in accordance with the quantization step size selected at step S4030. As indicated above, quantization may be performed in accordance with a psychoacoustic model for quantization, wherein a quantization step size determined by the psychoacoustic model is modified at step S4030.

FIG. 5 exemplarily illustrates details of step S4020 in FIG. 4.

As indicated above, the frequency resolution (e.g. of the scale factor bands) for short transform lengths may not be sufficient for reliably detecting tonality of the audio signal, e.g. in a given frequency band, such as the lowest frequency band. In order to nevertheless detect tonal components of the audio signal that may result in potentially audible artifacts, an increase in frequency resolution is required.

Since in the simple psychoacoustic model of e.g. the AC-4 encoder 4 MDCT lines are grouped together into one scale factor band at the lowest frequencies, a frequency resolution increase by a factor of 4 could be achieved by using a smaller bandwidth of 1 frequency line (MDCT line) for the detection. Additionally, a regular FFT might be applied for calculating the masking threshold which however would be computationally expensive. The tonality estimation accuracy based on the present MDCT might be improved by adding energies of several frequency coefficients within the scale factor band in question, thereby partly compensating for the fact that the MDCT is not energy preserving, i.e. that MDCT coefficients may fluctuate. However, these techniques either require high computational complexity or do not result in a frequency resolution sufficient for reliably detecting tonal components of the audio signal in the scale factor band in question.

Broadly speaking, in the proposed method a tonal component of the audio signal is detected in the frequency coefficient domain (e.g. MDCT domain)—after transform size decision—by averaging energy over a sequence of time-frequency transforms (e.g. MDCT transforms) with the same transform length, that are adjacent in time, and by detecting a steep energy rise (or steep energy drop) from lower to higher frequencies. In other words, energies of frequency coefficients are not added up over frequency, but over time, thereby accumulating energies of frequency coefficients of time-adjacent blocks of frequency coefficients.

At step S5010, which may be referred to as an averaging step, an indication of an averaged (or accumulated) energy for the respective frequency coefficient is determined for each frequency coefficient in the relevant frequency band of the audio signal. Said indication may be determined by averaging over frequency coefficients of corresponding frequency in each of the blocks of frequency coefficients among said sequence. In other words, energies of frequency coefficients (e.g. corresponding to the squares of the respective frequency coefficients) may be averaged (or accumulated) over time. For example, coefficient energies with the same frequency for the same transform length in a given frame may be averaged (or accumulated) over time, thereby compensating for the non-energy preserving property of the MDCT.

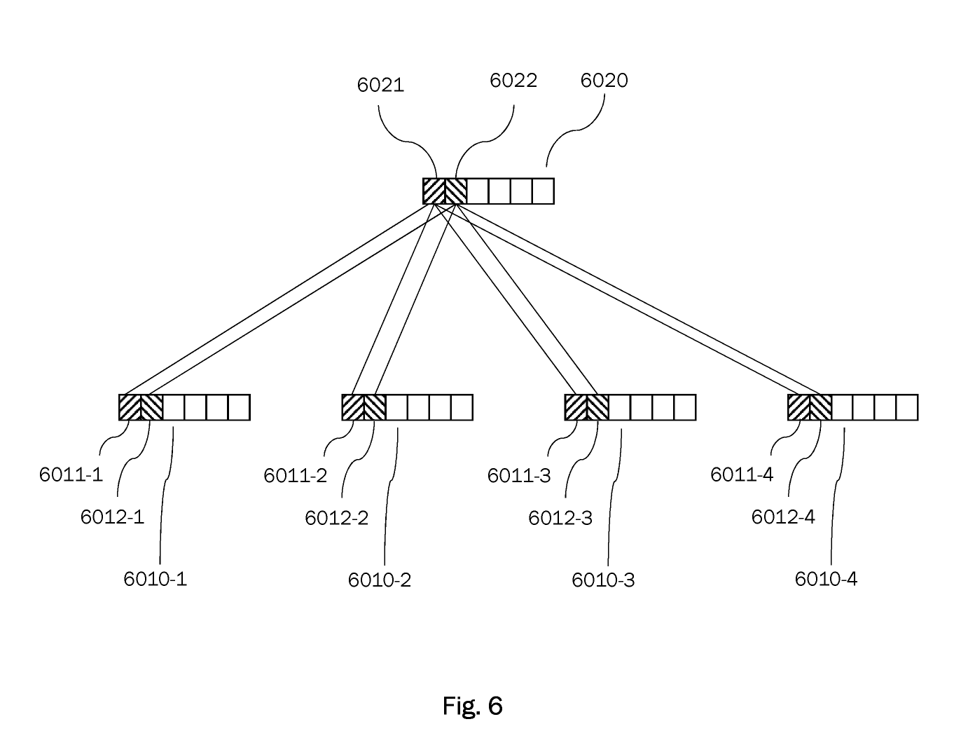

FIG. 6 schematically illustrates an example of details of step S5010. Reference numerals 6010-1 to 6010-4 indicate blocks of frequency coefficients (e.g. MDCT coefficients) in a sequence of blocks of frequency coefficients (e.g. 4 blocks of frequency coefficients in the example of FIG. 6). Coefficient energies of corresponding frequency coefficients in the several blocks of frequency coefficients in the sequence are averaged (or at least summed over). Said energies of frequency coefficients may be obtained by squaring the values of respective frequency coefficients. After squaring of its frequency coefficients, each block may be seen as a discrete spectrum at a given instance in time. Frequency coefficients are referred to as corresponding frequency coefficients if they relate to the same frequency or same frequency sub-band. For example, the lowest frequency coefficients 6011-1 to 6011-4 in each block are corresponding frequency coefficients, and the next-to-lowest frequency coefficients 6012-1 to 6012-4 in each block are corresponding frequency coefficients, and so forth. Said averaging (or summing) may be said to result in a time-averaged block of frequency coefficients (or time-accumulated block of frequency coefficients) 6020. For example, the energy of the lowest-frequency frequency coefficient 6021 of the time-averaged block of frequency coefficients 6020 may be obtained by averaging over the energies of the lowest-frequency frequency coefficients 6011-1 to 6011-4 in each block of the sequence, and the energy of the next-to-lowest frequency coefficient 6022 of the time-averaged block of frequency coefficients 6020 may be obtained by averaging over the energies of the next-to-lowest-frequency frequency coefficients 6012-1 to 6012-4 in each block of the sequence. After squaring of its frequency coefficients, the time-averaged block of frequency coefficients may be seen as a time-averaged (or time-accumulated) spectrum.

Time-averaging (or summing) may be performed for each frequency (for each frequency sub-band) in the relevant frequency band of the audio signal. For example, said frequency band may comprise a given number of consecutive frequencies (frequency sub-bands, e.g. MDCT lines) starting from the lowest frequency (frequency sub-band, e.g. MDCT line). For example, said averaging (or summing) may be performed for the 4 lowest MDCT lines.

Thus, instead of accumulating energies of frequency coefficients (e.g. MDCT coefficient energies) over frequency (e.g. for some or all frequency coefficient lines of a relevant scale factor band), the proposed method accumulates energies of frequency coefficients over time. As indicate above, this enables improvement of the amplitude estimate and thus results in an increased amplitude resolution (at the cost of time resolution). The time-averaged (or time-accumulated) block of frequency coefficients may be seen as a high amplitude resolution representation of the relevant portion of the audio signal.

By the above processing, an amplitude resolution may be obtained that is comparable to that of a psychoacoustic model using a complex transform such as a FFT with the same transform length. However, this frequency resolution is obtained at significantly lower computational complexity. By providing for the increased accuracy, changes in energy over frequency, such as spectral dips and strong increases in energy can be detected that would not be observable otherwise.

Returning to FIG. 5, at step S5020 the tonality measure is determined on the basis of the averaged (or summed) energies for the frequency coefficients in the relevant frequency band of the audio signal obtained at step S5010. Notably, the reliability of such a measure using the averaged (or summed) energies is increased with respect to using the energies of the frequency coefficients of each block of frequency coefficients in the sequence.

Step S5020 may be referred to as a determination step. Said determination step may involve detecting an increase or decrease from the averaged (or summed) energy of one frequency coefficient in said frequency band to the averaged (or summed) energy of an adjacent frequency coefficient in said frequency band (i.e. of a frequency coefficient adjacent in frequency to the one frequency coefficient, e.g. the next highest frequency coefficient). In other words, the determination step may involve identifying strong spectral dips or strong energy increases within the frequency band. As indicated above, the frequency band may correspond to the lowest scale factor band. Presence of energy increases or decreases (in general, changes) with an absolute magnitude above a given threshold may be indicative of a tonal component in the relevant portion of the audio signal. Any statements with regard to determining a tonality measure by analyzing energy changes that have been made above in the context of FIG. 1 to FIG. 3 are understood to apply also here.

By the above approach of considering time-averaged frequency coefficients (e.g. MDCT coefficients) for a single frequency, instead of adding up e.g. the whole scale factor band, the frequency resolution can be increased by a factor of 4 for the example of AC-4. A further increase of frequency resolution could be achieved by a hybrid approach with an additional frequency transform of the frequency coefficients of the frequency band under consideration (e.g. the lowest scale factor band). That is, determining the measure of tonal characteristics may involve applying a further frequency transform to the frequency coefficients in each block of frequency coefficients among the sequence.

Alternatively, the determination step may involve performing linear prediction over time adjacent blocks of frequency coefficients in said frequency band and measuring the prediction performance. Good agreement between predicted values and actual values (e.g. prediction error energy below a given threshold) may be indicative of tonal character of the audio signal.

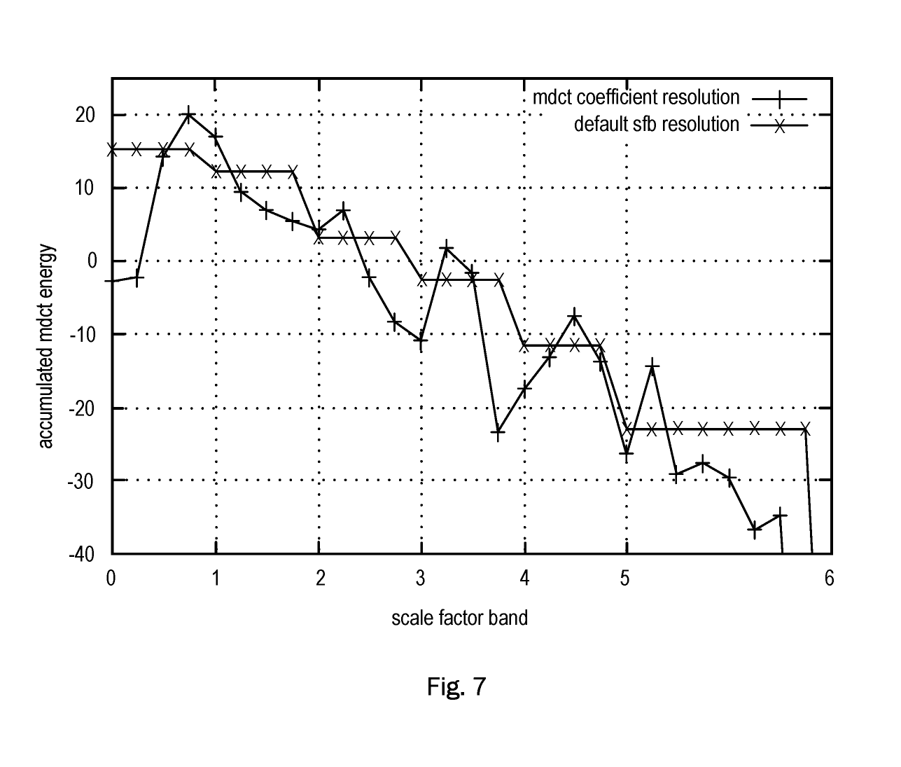

FIG. 7 is an exemplary graph illustrating the increase in frequency resolution that is obtainable by the proposed method in the context of the AC-4 codec for a given example frame. The abscissa indicates scale factor bands, wherein each scale factor band includes 4 MDCT lines in the lowest 5 bands. The ordinate indicates energy. The dark-grey line (connecting “+”) indicates time-averaged energies as obtained by the proposed method, and the light-grey line (connecting “x”) indicates frequency-averaged (average over one scale factor band) energies of MDCT coefficients. In the example frame, an energy difference of more than 20 dB is visible and detectable in the first scale factor band only for the higher resolution representation (indicated by the dark-grey line). Energy differences in higher scale factor bands may not be perceived as audible if the bandwidth of the scale factor band under investigation is smaller than or equal to a critical band bandwidth.

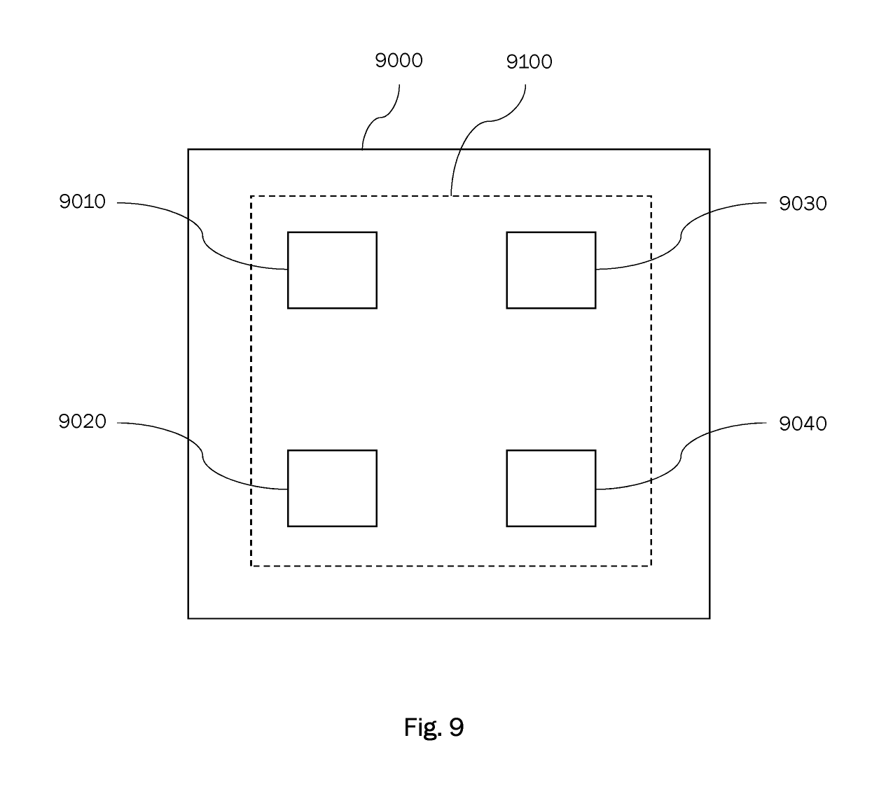

It is understood that the proposed method for improved bit allocation may be implemented by an encoder for encoding samples of an audio signal. Such encoder may comprise respective units adapted to carry out respective steps described above. An example of such encoder 9000 is schematically illustrated in FIG. 9. For instance, such encoder 9000 may comprise a time-frequency transform unit 9010 adapted to perform aforementioned step S4010, a tonality determination unit 9020 adapted to perform aforementioned step S4020, a quantization step selection unit 9030 adapted to perform aforementioned step S4030, and a quantization unit 9040 adapted to perform aforementioned step S4040. It is further understood that the respective units of such encoder may be embodied by a processor 9100 of a computing device that is adapted to perform the processing carried out by each of said respective units, i.e. that is adapted to carry out each of the aforementioned steps.

It should be noted that the description and drawings merely illustrate the principles of the proposed methods and apparatus. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the proposed methods and apparatus and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The methods and apparatus described in the present document may be implemented as software, firmware and/or hardware. Certain components may e.g. be implemented as software running on a digital signal processor or microprocessor. Other components may e.g. be implemented as hardware and or as application specific integrated circuits. The signals encountered in the described methods and apparatus may be stored on media such as random access memory or optical storage media. They may be transferred via networks, such as radio networks, satellite networks, wireless networks or wireline networks, e.g. the Internet.

1. A method of encoding samples of an audio signal, the method comprising:
determining a first measure indicative of transient characteristics of the audio signal;
determining a second measure indicative of tonal characteristics of the audio signal;
selecting, from a predetermined set of more than two transform lengths, a transform length for the audio signal on the basis of the first measure and the second measure; and
applying a time-frequency transform to a block of samples of the audio signal in accordance with the selected transform length, to thereby obtain a block of frequency coefficients corresponding to the block of samples of the audio signal,
wherein the transform length is selected in such a manner that the first measure satisfies a first threshold value of the selected transform length for the first measure and the second measure satisfies a second threshold value of the selected transform length for the second measure, wherein different transform lengths among the predetermined set of transform lengths have different associated threshold values for the second measure, such that longer transform lengths have less restrictive thresholds for the second measure than shorter transform lengths.

2. The method according to claim 1, wherein the time-frequency transform is a Modified Discrete Cosine Transformation, MDCT, and the frequency coefficients are MDCT coefficients.

3. The method according to claim 1, wherein the second measure is determined in the process of determining spectral band extension parameters for the audio signal.

4. The method according to claim 1, wherein determining the second measure involves:
applying a filterbank to the audio signal to generate a filterbank representation of the audio signal; and
determining the second measure on the basis of the filterbank representation of the audio signal.

5. The method according to claim 4, wherein the filterbank is a Quadrature Mirror Filter, QMF, filterbank.

6. The method according to claim 1, wherein the second measure is delayed with respect to the first measure so as to align the second measure with the first measure.

7. The method according to claim 1, wherein selecting the transform length involves:
a candidate transform length selection step of selecting a candidate transform length from a predetermined set of transform lengths on the basis of the first measure;
a transform length adjustment step of selecting, if the second measure does not satisfy a threshold value of the candidate transform length for the second measure, the next longer transform length from the predetermined set of transform lengths as a new candidate transform length; and
repeating the transform length adjustment step until the second measure satisfies the threshold value of the new candidate transform length for the second measure.

8. The method according to claim 1, wherein applying the time-frequency transform comprises:
applying the time-frequency transform in accordance with the selected transform length, to thereby obtain a sequence of blocks of frequency coefficients, wherein each block of frequency coefficients among said sequence corresponds to a respective block of samples of the audio signal,
and the method further comprises:
determining a third measure indicative of tonal characteristics for a frequency band of the audio signal based on the blocks of frequency components among said sequence;
selecting, for the blocks of frequency coefficients among said sequence, a quantization step size for the frequency coefficients in said frequency band on the basis of said third measure; and
quantizing, for the blocks of frequency coefficients among said sequence, the frequency coefficients in said frequency band in accordance with the selected quantization step size.

9. An encoder for encoding samples of an audio signal, the encoder comprising:
a transient determination unit adapted to determine a first measure indicative of transient characteristics of the audio signal;
a tonality determination unit adapted to determine a second measure indicative of tonal characteristics of the audio signal;
a transform length selection unit adapted to select, from a predetermined set of more than two transform lengths, a transform length for the audio signal on the basis of the first measure and the second measure; and
a time-frequency transform unit adapted to apply a time-frequency transform to a block of samples of the audio signal in accordance with the selected transform length, to thereby obtain a block of frequency coefficients corresponding to the block of samples of the audio signal,
wherein the transform length is selected in such a manner that the first measure satisfies a first threshold value of the selected transform length for the first measure and the second measure satisfies a second threshold value of the selected transform length for the second measure, wherein different transform lengths among the predetermined set of transform lengths have different associated threshold values for the second measure, such that longer transform lengths have less restrictive thresholds for the second measure than shorter transform lengths.

10. The encoder according to claim 9, wherein the time-frequency transform is a Modified Discrete Cosine Transformation, MDCT, and the frequency coefficients are MDCT coefficients.

11. The encoder according to claim 9, wherein the tonality determination unit is adapted to determine the second measure in the process of determining spectral band extension parameters for the audio signal.

12. The encoder according to claim 9, wherein the tonality determination unit is adapted to:
apply a filterbank to the audio signal to generate a filterbank representation of the audio signal; and
determine the second measure on the basis of the filterbank representation of the audio signal.

13. The encoder according to claim 12, wherein the filterbank is a Quadrature Mirror Filter, QMF, filterbank.

14. The encoder according to claim 9, wherein the second measure is delayed with respect to the first measure so as to align the second measure with the first measure.

15. The encoder according to claim 9, wherein the transform length selection unit is adapted to perform:
a candidate transform length selection step of selecting a candidate transform length from a predetermined set of transform lengths on the basis of the first measure; and
a transform length adjustment step of selecting, if the second measure does not satisfy a threshold value of the candidate transform length for the second measure, the next longer transform length from the predetermined set of transform lengths as a new candidate transform length; and
the transform length selection unit is adapted to repeat the transform length adjustment step until the second measure satisfies the threshold value of the new candidate transform length for the second measure.

16. A non-transitory computer-readable storage medium comprising instructions which, when performed by one or more processors, cause the one or more processors to execute the steps of the method according to claim 1.
